(19) United States
(12) Patent Application Publication
(10) Pub. No.: US 2015/0032508 A1
(43) Pub. Date: Jan. 29, 2015

(54) Systems And Methods For Probing Customers And Making Offers In An Interactive Setting

(71) Applicant: INTERNATIONAL BUSINESS MACHINES CORPORATION, Armonk, NY (US)

(72) Inventors: Rohit M. Lotlikar, Bangalore (IN); Pradeep N. Pachigolla, Vishakapatnam (IN); Virendra K. Varshneya, Aligarh (IN); Sneha S. Chaudhari, Pune (IN)

(73) Assignee: INTERNATIONAL BUSINESS MACHINES CORPORATION, Armonk, NY (US)

(21) Appl. No.: 13/953,133

(22) Filed: Jul. 29, 2013

(51) Int. Cl. G06Q 30/06; G06Q 30/02

(52) U.S. Cl. CPC G06Q 30/0631; G06Q 30/0203
USPC 705/7.32

(57) ABSTRACT

Methods and systems for recommending a product to a customer based on the customer's responses to a prioritized list of questions. A list of questions to ask the customer is created based on stored customer identifiers. The list of questions is priorities based on a pre-existing propensity score associated with the customer, and the agent asks the ranked questions. Based on the response of the customer, the propensity score and/or the list of questions is updated, and the agent is presented with a recommended product to suggest to the customer.

### BACKGROUND

The present invention relates generally to customer service systems and methodologies, and more particularly such systems that utilize real-time information in an interactive setting.

### DESCRIPTION OF THE RELATED ART

Guided selling solutions walk a customer through a series of questions for the ultimate purpose of making a product recommendation. Most often the solution centers around static sets of questions asked serially. In the more sophisticated solutions, the response to each question would lead to a particular next question, with the answer to the penultimate question leading to a product recommendation that is consistent with the customer's answers to the series of questions asked. The solutions, however, are not individualized, or to the extent individualized, are not capable of taking real-time responses into consideration in making the product recommendation.

### BRIEF SUMMARY

It is therefore a principal object and advantage of the present invention to provide a guided selling solution that takes a customer's historic data into consideration as well as the real time responses given in response to targeted questions that are programmatically determined.

Other objects and advantages of the present invention will in part be obvious, and in part appear hereinafter.

In accordance with the foregoing objects and advantages, a method for recommending a product to a customer based on the customer's responses to a prioritized question comprising the steps of: (i) providing a computer having a database stored in the memory thereof and in which data is stored, the data representing a bank of questions, identifiers for a plurality of customers, and pre-existing propensity scores associated with the plurality of customers; (ii) establishing communication with the customer; (iii) computing a list of questions for the customer based on one of the identifiers for the customer, wherein the list comprises a predetermined number of questions; (iv) prioritizing the list of questions based on the pre-existing propensity score for the customer; (v) asking the customer at least one of the questions based on the prioritization; (vi) entering in the computer a response of the customer to the at least one of the questions; (vii) electronically updating the propensity score for the customer based on the entered response; and (viii) recommending a product to the customer based on the updated propensity score.

According to an aspect, the method further comprises the step of updating the list of questions based on the entered response to the at least one of the questions.

According to another aspect, the recommending step comprises identifying, to an agent, the product to be recommended to the customer based on the updated propensity score, and recommending the product to the customer.

According to an aspect, the predetermined number of questions is three.

According to another aspect, each question in the list of questions is associated with a rank.

According to an aspect, the prioritizing step comprises prioritizing the list of questions based on the rank associated with each question in the list of questions.

According to an aspect, the method further comprises the step of storing in the database a response of the customer to the recommendation.

According to an aspect, the method further comprises the step of revising the rank associated with at least one question in the list of questions based on a response of the customer to the recommendation.

According to an aspect, at least some of the identifiers for a plurality of customers comprise demographic information.

According to another aspect, a non-transitory computer-readable storage medium containing program code comprising: (i) program code for computing a list of questions for the customer based on at least one customer identifier, the at least one customer identifier stored in a database, wherein the list comprises a predetermined number of questions; (ii) program code for prioritizing the list of questions based on the pre-existing propensity score for the customer; (iii) program code for receiving an entered response of the customer to at least one of the questions; (iv) program code for electronically updating the propensity score for the customer based on the entered response; (v) program code for identifying the product to be recommended to the customer based on the updated propensity score.

According to an aspect, the storage medium further comprises program code for updating the list of questions based on the entered response to the at least one of the questions.

According to an aspect, the predetermined number of questions is three.

According to an aspect, each question in the list of questions is associated with a rank.

According to an aspect, the program code for prioritizing comprises program code for prioritizing the list of questions based on the rank associated with each question in the list of questions.

According to an aspect, the storage medium further comprises program code for storing in the database a response of the customer to the recommendation.

According to an aspect, the storage medium further comprises program code for revising the rank associated with at least one question in the list of questions based on a response of the customer to the recommendation.

According to an aspect, a system for recommending a product to a customer based on the customer's responses to a prioritized question, the system comprising: (i) a computer having an associated database in which data is stored, the data representing a bank of questions, identifiers for a plurality of customers, and pre-existing propensity scores associated with at least some of the plurality of customers; (ii) a communications protocol adapted to communicate with the customer; (iii) a question selection module, the question selection module adapted to compute a list of questions for the customer based on one of the identifiers for the customer; (iv) a propensity scoring module, the propensity scoring module adapted to prioritize the list of questions based on a pre-existing propensity associated with the customer, and further adapted to update the propensity score for the customer based; (v) a user interface associated with the computer, wherein the user interface is adapted to present to an agent the list of questions for the customer and to receive a response of the customer to at least one of the list of questions, and wherein the user interface is further adapted to present to the agent a product to be recommended to the customer based on an updated propensity score.

According to an aspect, the question selection module is further adapted to update the list of questions based on the entered response to the at least one of the questions.

According to an aspect, each question in the list of questions is associated with a rank.

According to an aspect, the propensity scoring module is adapted to prioritize the list of questions based on the rank associated with each question in the list of questions.

According to an aspect, a response of the customer to the recommended product is stored in the database.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a schematic flow-chart of a process according to one embodiment;

FIG. 2 is a diagram of the example logic used for the questions selection function according to one embodiment;

FIG. 3 is a diagram of the example logic used for updating the propensity delta according to one embodiment;

FIG. 4 is a schematic of a system according to one embodiment; and

FIG. 5 is a schematic of a system according to one embodiment.

### DETAILED DESCRIPTION

Studies of sales performance have shown that tenure (experience) has a key bearing on sales performance. Salespeople tend to form mental models that sub-consciously categorize customers and associate different sales strategies with different categories. If agents probe customers before making a product offer, additional information gleaned from probing customers can, over time, help agents form better mental models to categorize customers. According to one embodiment is described an interactive decision support solution for call center agents to improve sales performance. Notably, the methods and systems described here can be applied to other scenarios such as helping agents handle customer complaints, troubleshooting, and retaining attriting customers.

According to one embodiment is an example in which a customer has just received a new credit card from a bank. The customer may be eligible to be cross-sold a number of other products, but being a new customer, there is no historical behavioral data on that customer to estimate propensities for various products. This is known as a ‘cold start’ problem. However, in a call center setting, asking the customer the reason they applied for a new card can give valuable clues. For example, a customer who says they were attracted by the reward program may be more receptive to an additional card for a family member. A customer who was in need of additional credit may be more receptive to a balance transfer from another card or to an increase in the credit limit. A customer attracted by airline partner affiliation may be receptive to some travel related offers. On the other hand, blindly offering a credit limit increase to someone who does not leverage credit might only waste the agent's and the customer's time, even resulting in an unpleasant customer experience.

### Example 1

### Problem Setting

According to this example is the credit card servicing call center of a large global bank that handles activities ranging from activating credit cards, to servicing customers, to maintaining accounts. Selling pre-defined banking and insurance products to customers in the last portion of the call is expected from agents. The qualitative performance metric for these agents include the customer satisfaction (“CSat”), average handle time (“AHT”) metrics and the ratio of selling offers made vs. offers accepted by customers.

Credit card activation call flow begins with a customer calling the bank's IVR number to activate a newly-received card (either a new card or a replacement card). The call is routed to an agent who starts engaging the customer and verifies her details. Once the identity is established, the agent activates the card, and then has the option of offering her one of the n number of products she is qualified for. This list of products is ranked based on the bank's own historical data based propensity models in the background. The agent desktop application shows this ranked list of offers to the agent for potentially offering to the customer.

This is the kind of baseline technology support available to call center agents in the selling scenario we are focusing on. The interaction between the agent and customer is not exploited as a data source here. This led us to believe that developing a solution like NBACC described subsequently, can provide solid revenue improvements (a fact validated in Sec. V). At the same time, the goal of our work was also exploring whether agents as working in process driven industries like call centers can actually be trained to use data mining technology.

### Example 2

According to one aspect is a process known as Next-Best-Action for Contact Centers (“NBACC”) in the context of a credit card call center of a global bank. The starting point customer data available to the call center comprises traditional non-personal non-sensitive customer data. This comprises, among other things: (i) demographic information such as age, gender, marital status, income; (ii) credit card features such as card type, annual fee, tenure, interest rate, and other product holdings at the bank like mortgages, loans; and (iii) account snapshot such as 3-month spending in each category, on-time payment behavior, and balance carry behavior. In addition, specific to the call center setting, also available is historical product sales data for six months prior to the start of NBACC solution development. This data contained, for each caller, information about her eligible product offers, offers made by agents, and offers accepted by the customer. According to this example, the bank had 10 products out of which 8 were considered core products, and 2 were non-core products. In a call, the agent was allowed to offer a maximum of 2 core products, and 1 non-core product. The core products were: Balance Transfer (BT), Additional Card (AC), Transaction Account (TA), Savings Account (SA), Credit Insurance (CI), Mortgage Lead (ML), Life Insurance Lead (LIL), Credit Limit Increase (CLI). The non-core products were Electronic-statement (ES), and Marketing opt-in (MO). NBACC was used only for selecting among the core products.

While an agent is allowed to make a maximum of two core products offers, there were a good proportion of instances in which the customer was eligible for less than two core products. There were also a significant proportion of calls for which there were at least two core products available to offer, yet the agent made less than two core product offers. The agents are instructed not to push offers when there are clear signs that that it will degrade the customer experience during the call. For example, if the voice quality is poor, if there are language barriers, or the customer appears rushed, then agents do not make any offers. At other times, after making the first offer, the agent decided not to make additional offers based on the customer's receptivity to the first offer.

Since the overall objective is to maximize revenue, at least two metrics can be considered according to one example—the average Revenue-per-Offer (RPO) and the average Revenue-per-Call (RPC). Whether agents make offers or not (with or without NBACC), is driven by soft uncontrollable factors such as how they judge the customer and the ongoing conversation. Even without NBACC when they do make offers, the background propensity models are scoring and ranking product offers. Hence, only RPO—and not RPC—is used as the metric to evaluate effectiveness of NBACC against the standard propensity driven static sales process.

A significant percentage of callers were customers who credit card accounts were newly opened (′new-to-bank′ or “NTB”) and hence such account snapshot data was not available for these customers. It is easy to see that among demographic, card feature, and snapshot data, the latter is likely to be the most informative data source. This led the building of separate product level propensity models for existing and new-to-bank customers. This splitting of customers enabled development of better discriminating models for both customer types in our internal cross-validation tests.

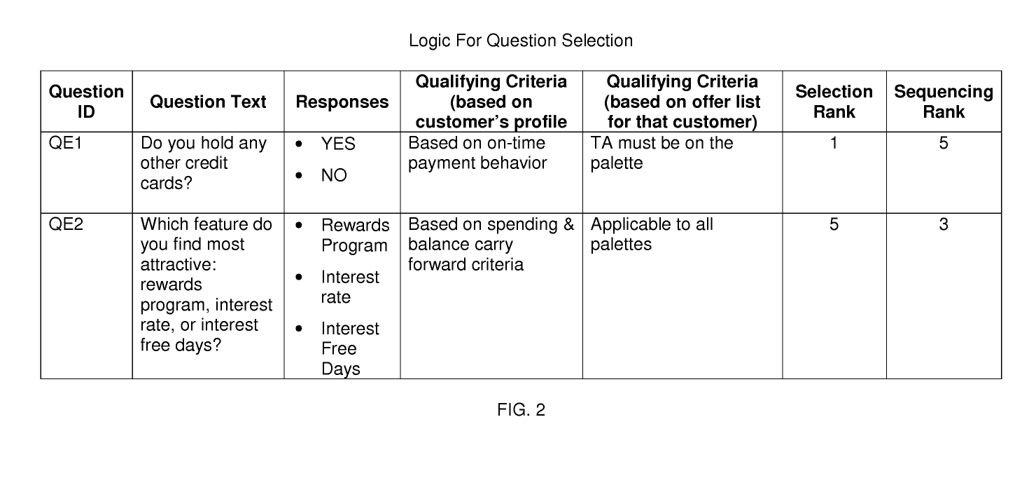

According to one embodiment of this example, a starting point for probing customers is to prepare a bank of questions that agents can ask customers. The customer's responses to these questions are expected to provide useful information concerning her propensity towards one or more offers. Inspecting the decision tree of the propensity model gave clues to which features were important drivers of propensity for various products. Based on these clues and discussions with domain experts, a set of 15 questions were prepared and the associated categorical responses. FIG. 2 shows two sample questions. The question “Do you hold any other credit cards?” was introduced because it was seen that possessing another credit card from a different bank has an important bearing on the customer's perceptions towards multiple products as it indicates that the customer has other avenues available to fulfill his needs.

Since agents have to aim to balance the trade-off between AHT, CSat, and sales performance, and to enhance the customer's experience, the number of questions that can be asked to a customer is limited to three, although according to other embodiments the number of questions may be more or less. The selection of up to three questions from the Question Bank to probe the customer on the phone and the sequencing of these questions is driven by the following specific logic.

Questions vary in their discriminating power across customers, with some questions expected to be more discriminating for certain types of customers and less discriminating for some others. For example, the question “Is your current payment method convenient” can be expected to be discriminating for those customers whose on-time payment record is not very good. Then there are some questions which were created for the purpose of eliciting clues regarding propensity towards a specific product. If the product is not on the palette (eligibility list) for that customer, the question should be eliminated from consideration. Domain expertise encoded as business rules is used to shortlist questions for each customer. These business rules take the form of Qualifying Rules based on Customer Profile and Qualifying Rules based on Product Eligibility and are illustrated in FIG. 2.

Having applied these Qualifying Rules, the shortlist may have more than three questions. To pick three questions among the shortlisted ones, the Selection Rank values are used. Referring back to FIG. 2, it is shown that each question is associated with a Selection Rank value, which is an integer. These values are based on the discriminatory power of the questions. The three questions with highest selection rank from the shortlist are selected. The sequence in which these questions are asked to the customer is determined by the associated Sequencing Rank of that Question. This rank is decided based on how the interaction should proceed with customers. For example, the question “How does our reward program compare to other bank's reward program?” should not be followed by “Do you have other credit cards?” even if the latter has a lower Selection Rank. This sequencing is heavily biased by a domain expert.

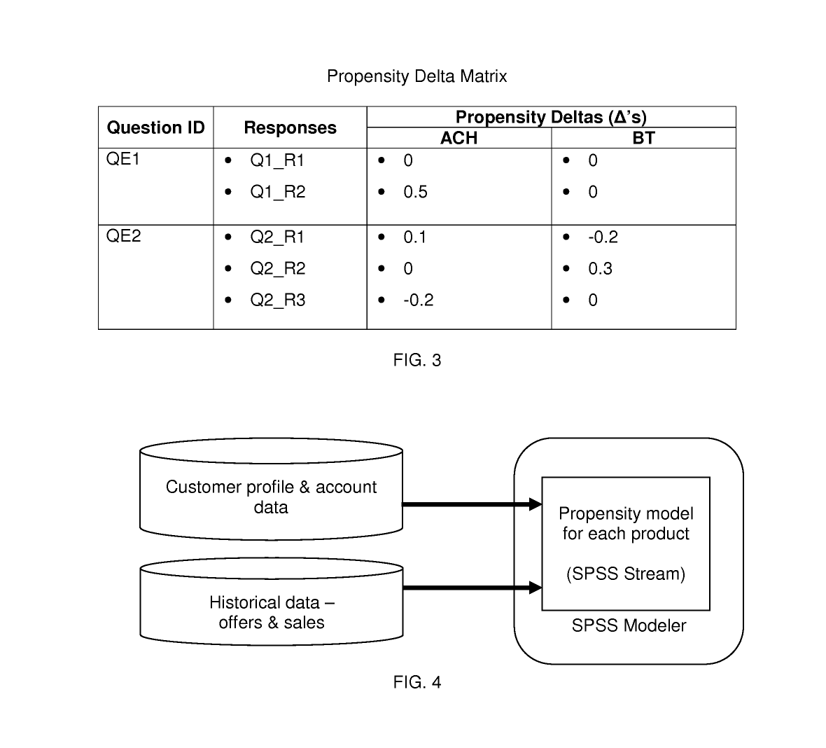

The response to each question gives an additional clue to the customer's propensity towards the available products. This knowledge is encoded in the form of a perturbation Δ(i,r) which is the perturbation corresponding to the response r to the question Qᵢ, as depicted in FIG. 3. For example, if a customer is asked the question “Do you hold any other credit cards?,” and the customer's response is “YES,” then the perturbation to the propensity for the Credit Line Increase (CLI) offer is 0.5. This perturbation is additive, i.e. given the response r to question Qᵢ, the posterior propensity is calculated as:

p^{post}=p^{prior}+Δ(i,r)

where P^{prior} is the propensity of the customer predicted by the decision tree based propensity model described above. FIG. 3 shows some examples.

The initial “cold-start” values of the Δ(i,r) are set based on hypothesis on the relationship between the response and the propensity. When the relationship is very strong or direct, a large value is set. An example of this is the relationship between possession of a credit card from another bank and the Balance Transfer offer. Possession of a credit card from another bank is essential to process a Balance Transfer offer. Therefore, the value of Δ(Q₁, ‘NO’) is a large negative value (−1.0) for the Balance Transfer product. Other than for such cases, the value of Δ(i,r) was set to increase or decrease the propensity by a value that is less than or equal to 2 standard deviations from the mean propensity for that product depending on the hypothesized strength of the relationship. However, note that these values should be, and were, tuned by correlating the responses with offer acceptance over the course of the time as described herein.

Different product offers result in different revenues for the bank. These updated posterior propensities are multiplied with the product value (thus “Revenue”), and this quantity is the expected gain from making the offer. The product recommendations are ordered according to it. Also allowed is higher prioritization of any one of the products, if there is a business defined requirement for promoting certain products from time to time.

Good user interaction design and implementation is essential to reduce adoption barriers and make it easy for the agents to interpret the recommendations from the system. According to one embodiment, the responses to the questions are in the form of drop-down list, although many other methods of user interaction are possible. Questions are presented one at a time. As each question is answered, the agent selects the drop-down entry for that question. The interface and logic were designed to update the ordering of products after each questions' response is entered rather than waiting for responses to all questions to be entered in order to make it easier for the agents to experience and interpret the logic.

### Example 3

### NBACC System Architecture

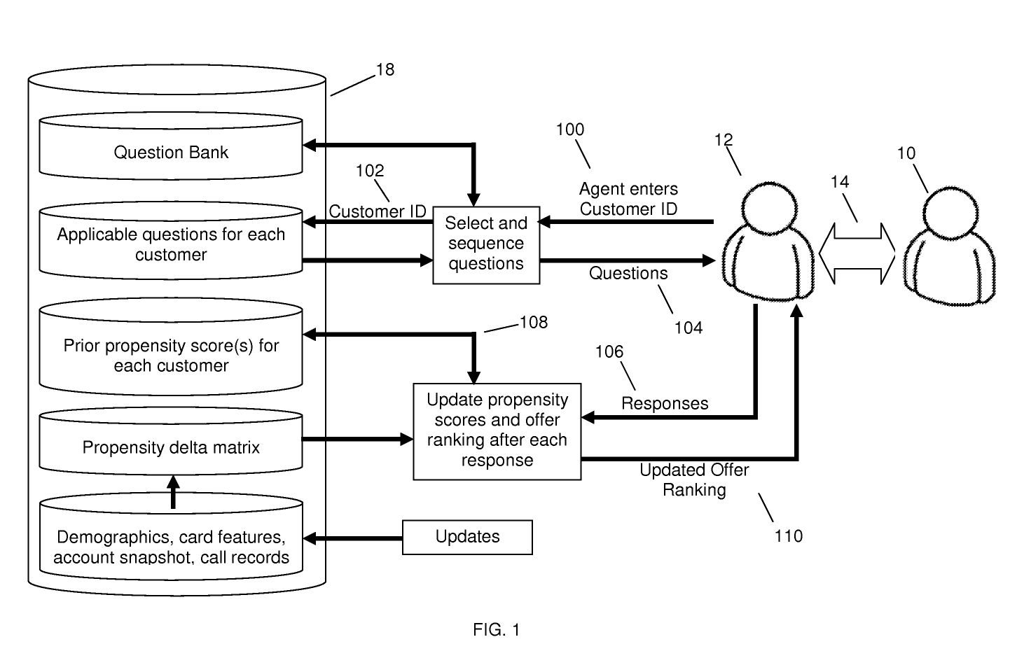

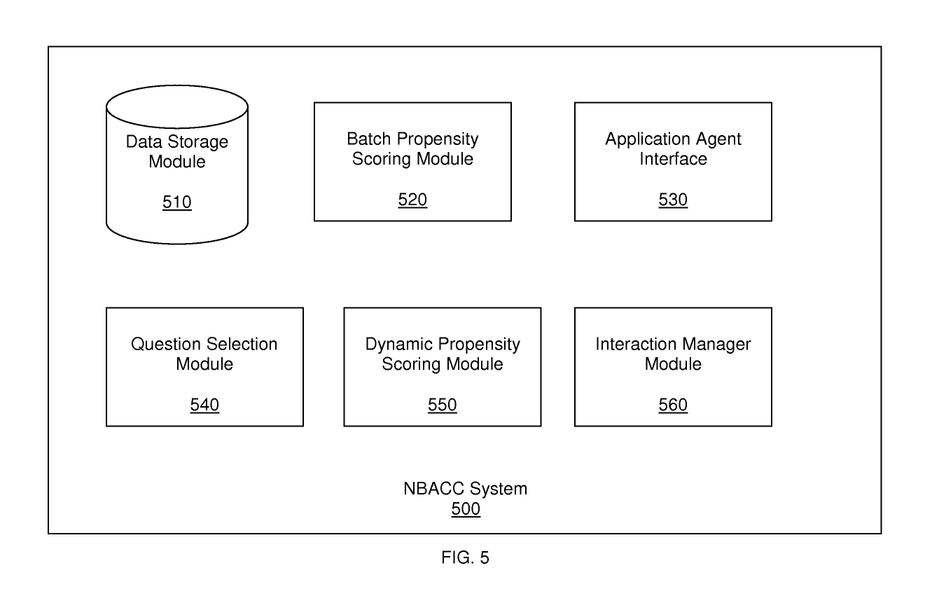

The architecture of one embodiment of an NBACC system 500 in the live call center environment is depicted in FIGS. 1 and 5. The three main decisioning components of the NBACC system are: (i) prior propensity computation; (ii) question generation; and (iii) dynamic updating of propensity scores. The additional components required to complete the solution are the data storage, interaction manger and front end. FIG. 5 depicts one example of how these components fit together to form the complete solution according to an embodiment.

Data storage module 510 in FIG. 5, which can be a commercial relational database package, preferably stores all data generated in the system. According to another embodiment, data storage module 510 comprises multiple databases in one or more locations. According to one embodiment, data storage module 510 is a virtual or cloud-based database.

Batch propensity scoring module 520 is a predictive modeling package with custom optimized implementation of decision trees. According to one embodiment, the module is used in a batch mode to perform a weekly update of propensity scores using the latest data from the bank. This weekly (or other timeframe) data extract contains data on NTB customers as well as updated data on existing customers with the fields as described elsewhere herein. According to one embodiment, batch propensity scoring module 520 is a commercially-available product.

An application agent interface module 530 is also shown in FIG. 5. According to one embodiment, the agent enters a customer ID which is passed back to the server to retrieve some key customer profile information to display in the shaded area below the customer id field. The complete list of core products is also displayed with check-boxes alongside. By looking up the product eligibility list for that customer (in a separate CRM application), the agent selects the products the customer is eligible for by filling the corresponding check-boxes. Then, these selected products are displayed in ranked order (initially in ranked order of prior propensities) in the right part of the GUI. AJAX web technology is used to minimize the information to be transmitted for updating a web page. This makes the front end very responsive, which is important because the page needs to be updated several times during the agent-customer conversation in a live call. Many other methods of using the applicant agent interface are possible.

System 500 also comprises question selection module 540. According to one embodiment, when the agent enters the products the customer is eligible for and submits, this module applies the business rules such as those depicted in Table I, and selects and orders the questions to be asked. These questions are sequentially passed on to the front-end.

System 500 also comprises Dynamic Propensity Scoring Module 550. According to one embodiment, as soon as the response to a question is entered, this module computes the posterior propensities using Equation 1 and updates the product rank-ings in the agent interface. Since the computation is very simple, the agent see the rankings being updated almost instantaneously after entering the response to a question.

System 500 also comprises an Interaction Manager Module 560. This module is a J2EE application which manages the agent-customer interaction as well as the communication between the various components. As soon as the agent enters the customer ID, Question Selection Module 560 is invoked to generate the questions, which are presented one at a time along with a drop-down list of possible responses. After the response to each question is entered, the Dynamic Propensity Scoring Module is then invoked to generate the posterior propensities and the associated product ranking. The Interaction Manager updates the product ordering in the GUI as per this product ranking.

The interaction manager is also responsible for an extensive interaction log capture. Some of the logs that are captured include: questions asked and their responses, sequence in which offers were displayed on the screen, the sequence in which the offers were proposed, etc. These logs are used to improve the system with manual intervention and by tweaking the rules and propensity A's driving the system based on extensive testing offline.

### Example 4

### Call Center Process Integration

According to one embodiment, the deployment is designed in such a way as to take into account different “in-call” eventualities, enabling the agent to make a prioritized offer at any point during the interaction with the customer. There can be different levels of offer rankings available to the agent. There is an initial offer ranking for every customer based on her profile using the historical propensity models. Further, as the agent interacts with the customer using NBACC, every question-answer pair re-ranks the offers based on the propensity As—so there are potentially three more re-rankings. Implementing this change needs careful agent training and there are other deployment considerations.

1) Agent training: According to one embodiment, call center agents follow a specific call flow while making offers to a customer. The questionnaire was introduced before the sales offer is made. According to one embodiment, the agents underwent a 3-stage training for NBACC: (i) Stage 1: The agents were given a formal classroom training which provided a background of the setup and how the solution is designed to assist them sell; (ii) Stage 2: The agents were asked to do role plays with the trainers using the NBACC application along with their complete existing call flow and using current desktop applications that they need to juggle during calls; (iii) Stage 3: Once the agents were comfortable with the system, they were asked to use NBACC in live calls and coached so that they were comfortable and felt confi-dent in using NBACC for making offers to customers.

2) Deployment considerations: There had to be awareness of certain real world considerations while deploying NBACC, including some of the following:

Experience of Agents: Using NBACC required some practice because agents had to toggle between the bank's native CRM application and NBACC in a tight 300 second call. According to one embodiment, the two features are integrated into a single application. The agents also had to find the balance between their judgment and the sales suggestions made by the NBACC.

Change management: In some of the calls, due to certain anomalies, the solution's rankings even contradicted with the agents' judgment. There was an initial resistance from agents towards NBACC, as some agents were averse to the risk of their sales falling and not meeting targets. To overcome initial resistance and to motivate agents, their incentives were restructured to align with usage of NBACC. Self-accountability was further introduced among the agents by regularly tracking usage of the tool through a manual tracker to be filled by them, and a daily usage report based on backend logs from the tool. As the agents overcame their resistance, got familiar with the tool, and learned to use it to their advantage in their calls, their performance improved. On average, agents took approximately two weeks to grow in confidence and start performing well and we realized the results in week three. The improvement in sales was accompanied by sale of higher revenue products as well as better conversion rates as shown quantitatively in the next section.

Impact on product mix: Some of the agents were not comfortable taking to the system because, in the status quo they were used to only offering products they were comfortable with. However with NBACC they were forced to offer other products as suggested by it. This pushed them out of their comfort zone and improved product mix. For example, some agents just kept offering Additional Cards because it is an easy product to sell. Now they also offered the Transaction Account (TA) product (which was harder to sell but had higher revenues associated with it) as well, because the system suggested so. Hence TA was sold more by the Test team when compared to the Control in our experiments described next.

Customer experience: Though a significant resistance from the callers to respond to questions was anticipated, most customers agreed to the questions. Very few customers did not answer, the main reason they cited was lack of time. This was encouraging though we recognize this behavior may be different depending on factors like local culture.

### Example 4

### Sample Testing

To perform controlled testing of the effectiveness of NBACC, experiments were designed with card activation agents to carefully measure their sales performance with and without using NBACC. There was a target of achieving 12% sales revenue improvement given our prior understanding of the problem setting.

Experimental Design: Agents were split into equal-sized Test and Control groups where the Test group used NBACC and the Control group did not. However, given the wide variation in sales performance among agents, the decision was made to break the timeline into two halves and flip the test and control groups midway to iron out the impact of individual performance differences. The two equal-sized groups of agents are called Team 1 and Team 2. For the first three weeks, Team I was the test group and Team 2 was the control group. At the end of the third week, the test and control groups were swapped. The first two weeks were considered as Team 1's adjustment and tuning period, during which time the call observations were used to tune the A values and the priority values of the different questions. Similarly the fourth and fifth weeks were considered as the adjustment period for Team 2. The third and sixth week were used as the evaluation period respectively.

TABLE II
Measurement Phases

| | | | | | | |
|---|---|---|---|---|---|---|
| Team | Week 1 | Week 2 | Week 3 | Week 4 | Week 5 | Week 6 |

| | | | |
|---|---|---|---|
| Team 1 | Train | Measure | No Use of NBACC |

| | | | |
|---|---|---|---|
| Team 2 | No Use of NBACC | Train | Measure |

For effective competitive comparison, outliers in the form of extremely good and extremely poor agents based on sales performance over three months prior to the deployment were removed. As explained elsewhere herein, a normalized metric of revenue per offer made or RPO (which is better than revenue-per-call RPC) was used to measure the performance of the agent in the call. The decision logic of NBACC is designed to maximize RPO defined as:

$$RPO = \frac{Total Revenue}{Number of Offers Made}$$

Overall for the core products, a 15-19% outperformance by the test team over control was observed. When all 10 core and non-core products were included, (non-core products were not part of the evaluation of NBACC), a 12-14% outperformance by the test group over the control group was observed.

To obtain a better understanding of how the system is helping, another analysis was performed to examine at how the RPO varies with the ranking of offers in the system. Clearly, optimally ordering product rankings to agents for the customers is the same problem as adjusting revenue weighted propensities in a sorted list as in NBACC. RPO must progressively decrease with rank if our system is performing correctly. The number of offers made, acceptance rate, and RPO as a function of the rank of the offer made in NBACC were used as ranking measures. The agents were asked to follow the system's ranked recommendations in making offers unless the customer asked about a certain product or provided some clues explicitly while talking that would indicate their need for a certain product. Identifying this was an important human aspect during the training phase of our deployment. It was discovered that agents generally followed the tool recommendations as evidenced from the figure—lower ranked products are offered less frequently. The RPO metric shows a clear trend as anticipated, with higher ranked offers being associated with higher RPO values.

As the deployment testing proceeded and data (logs) were collected on questions asked, customer responses and acceptances were used to tune the system logic. The tuning included reprioritization of questions and tuning of Δ's by correlating responses to questions with offer acceptances. This also provided insights on how the questions were helping out. Relationships were discovered between responses and propensities that were not expected from domain knowledge. To illustrate, one question was: “A number of our customers have multiple credit cards. May we know if you have other credit cards that you actively use apart from this credit card?” It was discovered that customers who do have a card from another bank have a significantly higher acceptance rate for the Life Insurance offer. Such data driven discoveries are very useful in practical deployment scenarios. They give us a lever to tweak the propensities in a rule-based manner rather than purely relying on statistical models. It is believed that this is an important handle to help balance the goodness of data driven analysis with domain knowledge and particular customer contexts.

TABLE 3
Relationship Between Other Credit Cards
and Acceptance of Life Insurance Offer.

| Response | Observed | Observed | Accepts conditioned |
|---|---|---|---|
| to Question | Accepts | Rejects | on Responses |
| YES | 27 | 35 | 44 |
| NO | 9 | 28 | 24 |

There is a wide spectrum in the skill and motivation levels of agents in call center settings owing to the repetitive nature of their work. Agent experience (or tenure) also plays a huge role in effective performance—for sales purposes as well as in general. It was expected that tenured experienced agents would quickly pick up NBACC and sell effectively, but one of the objectives of infusing technology like this was too see if relatively novice agents could also use the system and bootstrap their performance. While high performing agents learned to use the tool very quickly showing faster improvement in performance, the benefit was lesser when compared to the low performing agents.

This apparently surprising observation is actually intuitive; this is partly due to the fact that high performing agents had developed a high sense of assessment of the customer through the thousands of calls they had handled in the past. They use their judgment to sell products offered and were able to learn to leverage NBACC to their advantage very quickly. For the lower performing agents, the learning was a bit slower. Hence they had a higher resistance towards a new system which apparently disrupted the repetitive work they were used to. But eventually when they embraced the tool and grew confidence, they showed a very high degree of improvement compared to tenured agents already good at selling. NBACC has eventually been able to reduce the gap between the high skilled agents and the low skilled agents using deployed predictive analytics technology. As mentioned earlier, while this study focused on selling, extensions of NBACC to the problem solving use cases are expected to yield similar impactful benefits.

### Example 5

### Observations of Sample Testing

The agents took two weeks to learn and get familiarized with NBACC and learn to use it to their advantage. The outperformance of test team was observed from week three. Apart from the obvious improvement in performance, it helped scale up the newer agents faster. The lag time before the agents start performing well is now lesser. This is mainly because new agents take time to learn best practices, learn to judge customers, learn when to offer which product etc. NBACC mitigates this to an extent because, the newer agents no longer have to judge and think in the call but can right away go ahead and offer products.

In addition, not only did NBACC improve sales results, but there was a material improvement in the customer experience as part of the sales process. Many live calls in the call center were listened in on. A significant factor in the customer experience was how quickly the agents backed off from pushing a product when the customer had expressed a lack of interest in the product. Agents are under pressure to meet their weekly and monthly sales quotas and tend to push a product even when the customer is not receptive. Scientifically sequenced questions and recommendations helped agents make better judgments on how far they should push a products and this enhanced customer experience. Further, decision rules can be modified in such a manner that if the bank wants to promote certain product, it can easily do so by post-processing the prior propensity values.

Customer receptiveness: As the analysis shows, probing customers can provide valuable clues regarding their propensity towards multiple products. One of the initial concerns was whether customers would react unfavorably to probing. It was reassuring that hardly any customers declined to answer the questions and participated. Of course there was a properly worded set of questions that was reviewed and approved by compliance and customer experience professionals of the bank. Agents were also limited to a maximum of 3 questions per customer.

Building better mental models for Agents: it is important not to force the agents to strictly follow NBACC recommendations, as it would make their job too mechanical. Allowing them the freedom to override recommendations keeps them motivated and maintains their interest in improving their ability to make good judgement calls. By giving them some freedom, agents remain motivated and will over time form mental models about situations where the tool recommendations work well and where they do not work as well. In fact, asking carefully selected questions and noting the customer responses in itself provides additional key information by which agents would improve their mental models of customer types.

Value of contextual information: Without NBACC agents are making judgments based on a limited amount of information they see on the screen (such as a customer's age, income, account overview, location). A lot of the value of the propensity models arises from the use of detailed information about the customer.

Interaction design: To gain confidence, it is important for agents to see and interpret how responses to questions are impacting the ordering of products. In the front-end implementation, the product ranking was immediately updated after each response was captured, as opposed to waiting until responses to all questions are captured.

According to one embodiment, a number of possible NBACC extensions are possible. For example:

(a) currently choice of next question does not depend on response to the previous question. As extensive operational data is gathered, the cross-effects of questions, offer acceptances can be studied, as can their correlations. By including domain experts, the selection of subsequent questions and responses can be analyzed and these can be optimized for maximal RPO or RPC as needed.

(b) According to one embodiment, business rules defining which questions are applicable for which customer profiles can be refined. In particular, learning from past observations enables one to create a finer granularity rule structure to improve the targeting of questions.

(c) The Δ's are currently independent of the customer segment. According to one embodiment, segmenting customers appropriately and structuring delta values at the segment level could improve performance. The formulation of the problem as simultaneous optimization of customer segments, segment level Δ's, and Qualifying Rules to maximize RPO is an interesting new research problem to solve.

(d) Finally, according to one embodiment the additional data relating to the outcomes from each call can be used to auto-update the base propensity models.

### Example 6

### Sample Method

The steps of a method according to one embodiment of the invention as applied in the setting of a contact center agent cross-selling to a customer on the phone are illustrated in FIG. 1. A customer 10 and a call center agent 12 communicate via a phone (or other communications) connection 14. At step 100, the agent 12 enters the customer's 10 identifying code (ID) into a computer or other user interface that is preferably deployed in a network having a database 18. The ID is communicated to database 18 in step 102 and the database then returns to the computer or user interface in step 104 a series of questions that have been selected and sequenced based on characteristics associated with the ID. Agent 12 asks customer 10 the prompted questions that are displayed on the computer or user interface and enters the customer's responses in step 106 which are then communicated to database 18. In step 108, prior propensity scores associated with the ID that are stored in database 18 are used to update the propensity score associated with the ID based upon the customer's responses to the questions. In step 110, database 18 then provides a ranking of offers for each customer response based upon the updated propensity score and the agent 12 communicates the ranked offers to the customer 10.

With respect to the second step, namely the selection of questions step 104, the computer program associated with the present invention individualizes each of the questions to the customer. The logic of the program selects those questions that are expected to be the most discriminatory for that customer. More specifically, assuming up to “n” questions can be asked to a customer, the questions are first shortlisted based on business rules. Next the questions are prioritized based on the business rules, and finally the top predetermined questions are ordered based on the business rules.

With respect to steps 108 and 110, customer responses to questions are used to update the propensity scores. In particular, each possible response to each question is associated with a propensity delta which is the quantity to be added to the base propensity. More generically, a function is provided that maps the base propensity to the posterior propensity as per the response value. The offer rankings in step 110 are automatically y updated and displayed immediately after each question is answered rather than waiting for all questions to be answered. This feature permits the agent 12 to interpret the logic/reasoning behind the change in offer rankings and gain confidence in the automated recommendations. In addition, after the system has been in operation for some predetermined period of time, and call observations are collected, the values of the propensity delta matrix are refined by correlating the responses to questions with responses to offers.

As will be appreciated by one skilled in the art, aspects of the present invention may be embodied as a system, method or computer program product. Accordingly, aspects of the present invention may take the form of an entirely hardware embodiment, an entirely software embodiment or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction performance system, apparatus, or device.

The program code may perform entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises instructions for implementing the specified logical function(s). It should also be noted that, in some alternative implementations, the functions noted in the block may occur out of the order noted in the figures. For example, two blocks shown in succession may, in fact, be performed substantially concurrently, or the blocks may sometimes be performed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Although the present invention has been described in connection with a preferred embodiment, it should be understood that modifications, alterations, and additions can be made to the invention without departing from the scope of the invention as defined by the claims.

What is claimed is:

1. A method for recommending a product to a customer based on the customer's responses to a prioritized question, the method comprising the steps of:
providing a computer having a database stored in the memory thereof and in which data is stored, said data representing a bank of questions, identifiers for a plurality of customers, and pre-existing propensity scores associated with the plurality of customers;
establishing communication with said customer;
computing a list of questions for the customer based on one of said identifiers for the customer, wherein said list comprises a predetermined number of questions;
prioritizing said list of questions based on said pre-existing propensity score for the customer;
asking said customer at least one of said questions based on said prioritization;
entering in the computer a response of the customer to the at least one of said questions;
electronically updating said propensity score for the customer based on said entered response; and
recommending a product to the customer based on said updated propensity score.

2. The method of claim 1, further comprising the step of:
updating the list of questions based on the entered response to the at least one of said questions.

3. The method of claim 1, wherein said recommending step comprises identifying, to an agent, the product to be recommended to the customer based on said updated propensity score, and recommending the product to the customer.

4. The method of claim 1, wherein said predetermined number of questions is three.

5. The method of claim 1, wherein each question in said list of questions is associated with a rank.

6. The method of claim 6, wherein said prioritizing step comprises prioritizing said list of questions based on the rank associated with each question in said list of questions.

7. The method of claim 1, further comprising the step of:
storing in said database a response of said customer to said recommendation.

8. The method of claim 6, further comprising the step of:
revising the rank associated with at least one question in said list of questions based on a response of said customer to said recommendation.

9. The method of claim 1, wherein at least some of said identifiers for a plurality of customers comprise demographic information.

10. A non-transitory computer-readable storage medium containing program code comprising:
program code for computing a list of questions for the customer based on at least one customer identifier, said at least one customer identifier stored in a database, wherein said list comprises a predetermined number of questions;
program code for prioritizing said list of questions based on said pre-existing propensity score for the customer;
program code for receiving an entered response of the customer to at least one of said questions;
program code for electronically updating said propensity score for the customer based on said entered response;
program code for identifying the product to be recommended to the customer based on said updated propensity score.

11. The storage medium of claim 10, further comprising program code for updating the list of questions based on the entered response to the at least one of said questions.

12. The storage medium of claim 10, wherein said predetermined number of questions is capped at a predetermined maximum number.

13. The storage medium of claim 10, wherein each question in said list of questions is associated with a rank.

14. The storage medium of claim 13, wherein said program code for prioritizing comprises program code for prioritizing said list of questions based on the rank associated with each question in said list of questions.

15. The storage medium of claim 10, further comprising:
program code for storing in said database a response of said customer to said recommendation.

16. The storage medium of claim 10, further comprising:
program code for revising the rank associated with at least one question in said list of questions based on a response of said customer to said recommendation.

17. A system for recommending a product to a customer based on the customer's responses to a prioritized question, the system comprising:
a computer having an associated database in which data is stored, said data representing a bank of questions, identifiers for a plurality of customers, and pre-existing propensity scores associated with at least some of said plurality of customers;
a communications protocol adapted to communicate with said customer;
a question selection module, said question selection module adapted to compute a list of questions for the customer based on one of said identifiers for the customer;
a propensity scoring module, said propensity scoring module adapted to prioritize said list of questions based on a pre-existing propensity associated with the customer, and further adapted to update the propensity score for the customer based;
a user interface associated with said computer, wherein said user interface is adapted to present to an agent said list of questions for the customer and to receive a response of the customer to at least one of said list of questions, and wherein said user interface is further adapted to present to said agent a product to be recommended to said customer based on an updated propensity score.

18. The system of claim 17, wherein said question selection module is further adapted to update the list of questions based on the entered response to the at least one of said questions.

19. The system of claim 17, wherein each question in said list of questions is associated with a rank.

20. The system of claim 19, wherein said propensity scoring module is adapted to prioritize said list of questions based on the rank associated with each question in said list of questions.

21. The system of claim 17, wherein said a response of said customer to said recommended product is stored in said database.
